(19) United States
(12) Patent Application Publication
(10) Pub. No.: US 2015/0080155 A1
(43) Pub. Date: Mar. 19, 2015

(54) Soccer ball and method of making a soccer ball

(71) Applicant: Zwyxis HongKong Co., Ltd., Central (HK)

(72) Inventor: Roy Bulfin, Ho Chi Minh City (VN)

(73) Assignee: Zwyxis HongKong Co., Ltd., Central (HK)

(21) Appl. No.: 14/026,171

(22) Filed: Sep. 13, 2013

(51) Int. Cl. B32B 37/24; B32B 37/10; B32B 38/08; B32B 37/12; B32B 38/00; A63B 41/08; B32B 37/14

(52) U.S. Cl. CPC B32B 37/24; A63B 41/08; B32B 37/1045; B32B 37/142; B32B 37/1207; B32B 38/0004; B32B 38/0012; B32B 38/08; A63B 2243/0025; B32B 2038/0016; B32B 2310/028; B32B 2375/00; B32B 2398/20
USPC 473/604; 156/242; 156/153; 156/73.1

(57) ABSTRACT

The invention is directed toward a soccer ball and a method of making a soccer ball. The method comprises the steps of forming a pair of molded semi-hemispheric core halves from an elastomer material, connecting the edges of the core halves together, permanently affixing the edges of the core halves together to form one sphere, applying adhesive to the surface of the sphere, cutting a surface material to a desired shape, applying adhesive to the back side of the surface material, applying the back of the surface material to the surface of the sphere, and allowing the adhesive to cure until the surface material is permanently affixed to the sphere. The synthetic material is cut into a predetermined shape to match the shape of a predetermined template prior to affixing the surface material to the core.

### TECHNICAL FIELD This invention relates to sports balls and more specifically to a method of making a soccer ball and particularly constructed soccer ball.

### BACKGROUND OF THE INVENTION

Soccer balls and methods of their manufacture are well known in the art. Conventional soccer balls are constructed with a stiff polymer exterior with an internal air bladder. A user inflates the interior bladder to the desired pressure prior to use on the field. The conventional construction presents several limitations. First, it may be difficult to obtain the desired internal pressure. If a user has a pump without a means for measuring pressure, the user may over internal bladder, making the soccer ball too stiff. Second, the internal bladder may be punctured, rendering the soccer ball flat and useless. Third, it is often difficult to achieve a consistent spherical shape during production as the shape is dependent upon the outer shell. Fourth, internal pressure is not consistent in conventional balls, either from ball to ball or during the lifetime of an individual ball. This variation in internal pressure affects the performance and response of the soccer ball during game play. What is needed is a soccer ball which does not utilize an internal inflatable bladder but still provides the proper level of pressure and response as a standard soccer ball. The present invention overcomes these limitations and provides a consistency not achievable with an inflatable ball. The invention offers many benefits over the standard soccer ball construction. The invention allows for the production of soccer balls which are more consistent in shape, more durable, and easier to mass produce.

### SUMMARY OF THE INVENTION

The invention is directed to a soccer ball and a method of making the soccer ball. The soccer ball is comprised of a hollow sphere of an elastomer material to which an outer covering is attached.

The core of the soccer ball is made from a synthetic rubber, a polymer, or any other type of elastomer used in commercial production. The types of material which can be used to form the core includes polybutadiene, polyurethane, polyisoprene, or any other type of commonly used synthetic or natural elastomer. The core can be comprised of one of these compounds or a mixture of any of these compounds. The elastomer compound is pressure molded to form semi-hemispheric halves. Two semi-hemispheric halves are then attached together to make a spherical core. The semi-hemispheric halves are affixed together by any means that can permanently affix the halves into one spherical core. In the preferred embodiment the edges of the two halves are covered with adhesive and then affixed together. Alternatively, the edges of the halves may be fused together by means of ultrasonic welding or high frequency welding. When attached together, the internal pressure is set at a desired level. Preferably, the desired level of internal pressure is 0.6 to 1.1 atmospheres at sea level. In the optimal preferred embodiment, the internal pressure is set at atmospheric pressure.

The core of the soccer ball may also be formed from a combination of polymers having separate physical properties. The polymers may be combined in stages such that the resulting core is formed in layers. In one embodiment of the invention, the core may have two differentiated layers forming a dual core. In this embodiment, the inner layer of the core is a relatively firm and hard polymer material. The outer layer of the core is a relatively softer external core.

An outer covering is attached to the core of the soccer ball. The outer covering of the soccer ball is a polymer based material with an abrasive resistant surface backed by a fabric and/or foam based sub structure. Most commonly this covering would be polyurethane or thermoplastic urethane. Additionally, the outer covering could comprise polyvinyl chloride (PVC). The PVC or the polyurethane covering may have a backing of woven fabric or yarn or microcellular foam. The outer covering is cut into a predetermined pattern and then affixed to the outer surface of the core. The pattern repeats around the surface of the core such that the entire surface of the core is covered by the outer material without the need to trim any additional material.

Normally, soccer balls have a special design, color, or graphic image applied to the outer covering. The invention includes the method of applying a desired design, color, or graphic to a polyurethane or thermoplastic urethane sheet, cutting out the desired pattern from the polyurethane or thermoplastic urethane sheet, and applying the cut out pattern to the surface of the core. In this manner, there are no actions or steps to perform to finish the soccer ball. Once the outer covering has been applied, the soccer ball is in its finished form. This speeds up the production process as no further action is required once the outer shell is applied.

The adhesive used to attach the semi-spherical core halves together and to attach the outer covering to the spherical core can be any adhesive or combination of adhesives employed in the production of conventional soccer balls. The adhesive may be self-curing. Alternatively, the adhesive may be heat-curable. With heat-curable adhesive, the proper amount of heat is to be applied to fully cure the adhesive used.

The process of applying the outer covering may include other processes and methods. In one embodiment, the core is dipped into a liquid polyurethane a desired number of times. The core is dipped into a liquid polyurethane. The liquid polyurethane naturally adheres to the surface of the core. The liquid polyurethane then dries and cures to a solid. Once the polyurethane is dry, the core can be dipped a second time in the liquid polyurethane. The liquid polyurethane naturally adheres to the surface of the core. This process can be repeated any number of times. Each time the core is dipped into the liquid polyurethane and dried, the size of the ball naturally increases. The process can be repeated until the size of the ball reaches the final desired size. Once the ball reaches the desired size the graphic design is applied to the outer surface of the ball and the ball is finished.

In another embodiment, the outer covering is applied by spraying the core with a liquid polyurethane. Heat is then applied to the ball to fix the polyurethane outer covering. A desired amount of liquid polyurethane can be sprayed onto the core until the ball reaches the desired size. For larger sizes, more polyurethane is sprayed onto the core. Once the outer covering is fixed the desired graphic design is pasted on.

The resulting soccer ball may be of any size. Preferably, the soccer ball is between 11 ounces to 16 ounces in weight and between 23 inches to 28 inches in circumference. In one embodiment of the invention, the resulting soccer ball may be sized anywhere from a size 0 to a size 3. These sizes are commonly referred to as skills balls.

The invention comprises a method of manufacturing the soccer ball. The invention comprises the steps of forming a pair of molded semi-hemispheric core halves from an elastomer material, connecting the edges of the semi-hemispheric core halves together, permanently affixing the edges of the semi-hemispheric core halves together to form one sphere, applying adhesive to the surface of the sphere, cutting a surface material to a desired shape, applying adhesive to the back side of the surface material, applying the back of the surface material to the surface of the sphere, and allowing the adhesive to cure until the surface material is permanently affixed to the sphere.

In another embodiment of the invention, the method further comprises creating a predetermined template of the desired shape of the surface material, prior to affixing the surface material to the sphere tracing an outline of the predetermined template on surface of the sphere, cutting the surface material in a desired shape which is substantially identical to the predetermined template, and aligning the surface material with the outline on the sphere when applying surface material to the sphere.

In another embodiment of the invention, the method further comprises sanding edges of the semi-hemispheric core halves prior to connecting edges of the semi-hemispheric core halves, applying adhesive to the edges of the semi-hemispheric core halves, and allowing the adhesive to cure until the semi-hemispheric core halves become permanently affixed.

In one embodiment of the invention the adhesive used is heat curable. The method in this embodiment further comprises heating the semi-hemispheric core halves until the adhesive cures and heating the final soccer ball until the adhesive on surface of the sphere and on back of the surface material cures.

In another embodiment the method further comprises sanding surface of the sphere prior to applying adhesive on surface of the sphere. In yet another embodiment of the invention the spherical core halves are permanently affixed by means of ultrasonic welding. In a separate embodiment of the invention the spherical core halves are permanently affixed by means of adhesive applied to the edges of the semi-hemispheric core halves.

In another embodiment of the invention, the semi-hemispheric core halves are comprised of a plethora of differentiated layers. The differentiated layers have different physical properties, such as rigidity, compression, or tensile strength.

In one embodiment of the invention the method further comprises sanding edges of the semi-hemispheric core halves prior to connecting edges of the semi-hemispheric core halves, applying adhesive to the edges of the semi-hemispheric core halves, allowing the adhesive to cure until the semi-hemispheric core halves become permanently affixed, creating a predetermined template of the desired shape of the surface material, prior to affixing the surface material to the sphere tracing an outline of the predetermined template on surface of the sphere, cutting the surface material in a desired shape which is substantially identical to the predetermined template, and aligning the surface material with the outline on the sphere when applying surface material to the sphere.

The invention is also directed toward the method of making a core for a soccer ball. The method for making a core for a soccer ball comprises forming a pair of molded semi-hemispheric core halves from an elastomer material, applying an adhesive means to the edges of the core halves, connecting the edges of the semi-hemispheric core halves together, and allowing the adhesive to cure until the semi-hemispheric core halves are permanently affixed together into a spherical shape.

The invention includes the method of making a soccer ball comprising forming a pair of molded semi-hemispheric core halves from an elastomer material, connecting the edges of the semi-hemispheric core halves together, permanently affixing the edges of the semi-hemispheric core halves together to form one sphere, applying an outer layer of liquid polyurethane to the sphere, allowing the liquid polyurethane to cure, and applying a graphic decal to the outer surface. Within this method the outer layer of liquid polyurethane may be applied by dipping the sphere into the liquid polyurethane. Furthermore, the polyurethane may be a thermoplastic urethane and the method further comprises heating the thermoplastic urethane to cure the thermoplastic urethane. In another embodiment of this method the outer layer of liquid polyurethane is applied by spraying the liquid polyurethane onto the sphere. Furthermore, the polyurethane may be a thermoplastic urethane and the method further comprises heating the thermoplastic urethane to cure the thermoplastic urethane.

The invention is directed toward a soccer ball comprising a generally spherical core formed of an elastomer material and a synthetic material affixed to the core. In another embodiment of the invention, the core of the soccer ball is formed by permanently affixing two semi-hemispherical core halves. Additionally, the synthetic material may be cut in a shape substantially equal to a predetermined template prior to affixing the synthetic material to the core. Furthermore, the synthetic material is permanently affixed to the spherical core by means of an adhesive. Additionally, the synthetic material may be affixed on the spherical core in a desired pattern. The synthetic material may be polyvinyl chloride. Furthermore, the ball may be between 11 and 16 ounces in weight and between 23 inches and 28 inches in circumference.

The invention is also directed toward a method of applying an outer finished surface material to a soccer ball core. The method of applying an outer finished surface material comprises formulating a desired pattern on the surface material, cutting blanks of the desired pattern from the surface material, applying adhesive to the backside of the surface material, and applying the backside of the surface material to a spherical core. The spherical core may comprise a pair of molded semi-hemispheric core halves from an elastomer material affixed together. The method may further comprise heating the adhesive to cure the adhesive.

### BRIEF DESCRIPTION OF THE DRAWINGS

FIG. 1 is a view of the semi-hemispherical core halves.

FIG. 2 is a view of a standard template of covering material.

### DETAILED DESCRIPTION OF THE DRAWINGS

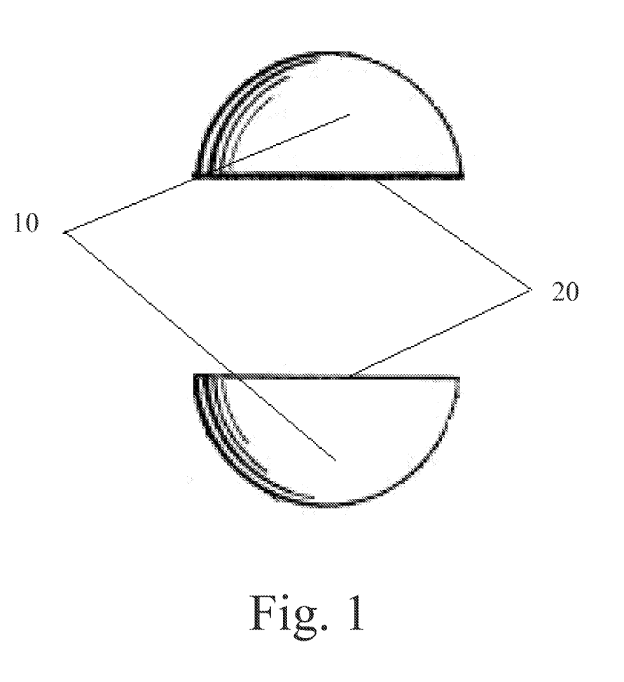

Referring to FIG. 1, the soccer ball is formed by two composite elastomer hemi-spherical core halves 10. The edges 20 of the hemi-spherical core halves 10 are placed together to form a complete sphere. The edges 20 of the hemi-spherical core halves 10 are affixed together with adhesive which is applied to the edges 20. Alternatively, the edges 20 may be fused together with ultrasonic welding.

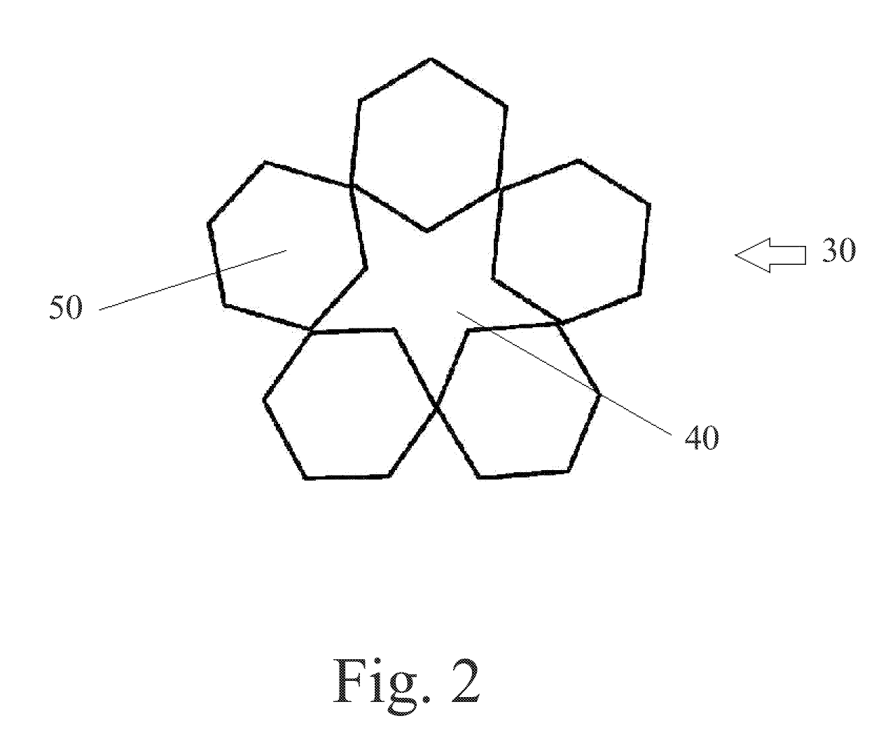

After the hemi-spherical core halves 10 are affixed together into one core, adhesive is placed on the surface of the core. Referring to FIG. 2, a predetermined template 30 is then used to cut out a shaped panel of the covering material for the core. FIG. 2 shows one embodiment of such predetermined template 30. Any repeating pattern normally used to cover soccer balls may be used for the predetermined template 30. Such predetermined template 30 may be a five point star 40 surrounded by five hexagons 50. Alternative patterns may include the standard soccer ball pattern of hexagons and pentagons or any other repeating pattern which may be used to cover the core of the soccer ball. In the preferred embodiment, the predetermined pattern 30 is the basic shape required such that the edges of the predetermined template 30 will join together with the edges of other predetermined templates 30 when affixed to the surface of the spherical core. In the preferred embodiment the predetermined template 30 is shaped such that the entire surface of the spherical core is covered when applying a specific number of predetermined templates 30 such that no partial predetermined template 30 is required to ensure total coverage of the spherical core.

1. The method of manufacturing a soccer ball comprising
Forming a pair of molded semi-hemispheric core halves from an elastomer material
Connecting the edges of said semi-hemispheric core halves together
Permanently affixing said edges of said semi-hemispheric core halves together to form one sphere
Applying adhesive to the surface of the sphere
Cutting a surface material to a desired shape
Applying adhesive to the back side of said surface material
Applying said back of said surface material to said surface of said sphere
Allowing said adhesive to cure until said surface material is permanently affixed to said sphere

2. The method as in claim 1 further comprising
Creating a predetermined template of said desired shape of said surface material
Prior to affixing said surface material to said sphere tracing an outline of said predetermined template on surface of said sphere
Cutting said surface material in a desired shape which is substantially identical to said predetermined template
Aligning said surface material with said outline on said sphere when applying surface material to said sphere

3. The method of claim 1 further comprising
Sanding edges of said semi-hemispheric core halves prior to connecting edges of said semi-hemispheric core halves.
Applying adhesive to said edges of said semi-hemispheric core halves
Allowing said adhesive to cure until said semi-hemispheric core halves become permanently affixed

4. The method of claim 1 wherein said adhesive is heat-curable and further comprising
Heating said semi-hemispheric core halves until said adhesive cures
Heating said final soccer ball until said adhesive on surface of said sphere and on back of said surface material cures

5. The method of claim 1 wherein said semi-hemispheric core halves comprise a plethora of differentiated layers and wherein said differentiated layers have different physical properties.

6. The method of claim 1 wherein the spherical core halves are permanently affixed by means of ultrasonic welding

7. The method of claim 1 wherein the spherical core halves are permanently affixed by means of adhesive applied to said edges of said semi-hemispheric core halves

8. The method of claim 1 further comprising
Sanding edges of said semi-hemispheric core halves prior to connecting edges of said semi-hemispheric core halves.
Applying adhesive to said edges of said semi-hemispheric core halves
Allowing said adhesive to cure until said semi-hemispheric core halves become permanently affixed
Creating a predetermined template of said desired shape of said surface material
Prior to affixing said surface material to said sphere tracing an outline of said predetermined template on surface of said sphere
Cutting said surface material in a desired shape which is substantially identical to said predetermined template
Aligning said surface material with said outline on said sphere when applying surface material to said sphere

9. The method of making a soccer ball comprising
Forming a pair of molded semi-hemispheric core halves from an elastomer material
Connecting the edges of said semi-hemispheric core halves together
Permanently affixing said edges of said semi-hemispheric core halves together to form one sphere
Applying an outer layer of liquid polyurethane to said sphere
Allowing said liquid polyurethane to cure
Applying a graphic decal to the outer surface

10. The method as in claim 9 wherein said outer layer of liquid polyurethane is applied by dipping said sphere into said liquid polyurethane

11. The method as in claim 10 wherein said polyurethane is a thermoplastic urethane and further comprising heating said thermoplastic urethane to cure said thermoplastic urethane

12. The method as in claim 9 wherein said outer layer of liquid polyurethane is applied by spraying said liquid polyurethane onto said sphere

13. The method as in claim 12 wherein said polyurethane is a thermoplastic urethane and further comprising heating said thermoplastic urethane to cure said thermoplastic urethane

14. A soccer ball comprising
A generally spherical core formed of an elastomer material
A synthetic material affixed to said core

15. The ball as in claim 14 wherein said core is formed by permanently affixing two semi-hemispherical core halves

16. The ball as in claim 15
Wherein said synthetic material is cut in a shape substantially equal to a predetermined template prior to affixing to said core
Wherein said synthetic material is permanently affixed to said spherical core by means of an adhesive
Wherein said synthetic material is affixed thereon in a desired pattern

17. The ball as in claim 16 wherein said synthetic material is polyvinyl chloride

18. The method of applying an outer finished surface material to a soccer ball core comprising
Formulating a desired graphic image or design on said surface material
Cutting blanks of a desired pattern from said surface material
Applying adhesive to the backside of said surface material
Applying said backside of said surface material to a spherical core

19. The method as in claim 18 wherein said spherical core comprises a pair of molded semi-hemispheric core halves from an elastomer material affixed together

20. The method as in claim 19 further comprising heating said adhesive to cure said adhesive
